(19) United States
(12) Patent Application Publication
(10) Pub. No.: US 2010/0283923 A1
(43) Pub. Date: Nov. 11, 2010

(54) LIQUID CRYSTAL DEVICE AND ELECTRONIC APPARATUS

(75) Inventor: Yasushi KAWAKAMI, Chino-shi (JP)

Correspondence Address: WORKMAN NYDEGGER;1000 Eagle Gate Tower, 60 East South Temple, Salt Lake City, UT, 84111, US

(73) Assignee: SEIKO EPSON CORPORATION, Tokyo (JP)

(21) Appl. No.: 12/775,612

(22) Filed: May 7, 2010

(30) Foreign Application Priority Data
May 11, 2009 (JP) 2009-114215

(51) Int. Cl. G02F 1/1343; G02F 1/1335

(52) U.S. Cl. 349/5; 349/139

(57) ABSTRACT

A liquid crystal device which includes a first substrate having a plurality of reflective pixel electrodes on a surface thereof, an optically transparent second substrate opposing the surface having the reflective pixel electrodes of the first substrate, and a liquid crystal layer between the first substrate and the second substrate, where the first substrate has antireflection films on side ends of the reflective pixel electrodes.

### BACKGROUND OF THE INVENTION

The entire disclosure of Japanese Patent Application No. 2009-114215, filed May 11, 2009 is expressly incorporated herein by reference.

### 1. TECHNICAL FIELD

The present invention relates to a reflective liquid crystal device and to an electronic apparatus including the liquid crystal device.

### 2. RELATED ART

A reflective liquid crystal device typically includes a first substrate including a plurality of pixel transistors and a plurality of reflective pixel electrodes, an optically transparent second substrate opposing the first substrate, and an a liquid crystal layer disposed between the first substrate and the second substrate. In such a liquid crystal device, light coming through the second substrate is modulated in the liquid crystal layer while the light is reflected from the reflective pixel electrodes emitted through the second substrate, as shown in the Japanese Patent Document No. JP-A-2005-181829.

In order to enhance the contrast of displayed images, the reflective liquid crystal device needs to enhance the surface smoothness of the reflective pixel electrodes and the orientation characteristics of the liquid crystal material.

However, the present inventors have found from their study that it is difficult to further increase the contrast only by enhancing the surface smoothness of the reflective pixel electrodes and the orientation characteristics of the liquid crystal material. More specifically, in a reflective liquid crystal device, if the light entering through the second substrate and passing through the spaces between the reflective pixel electrodes reflects from a layer below the reflective pixel electrodes to the side ends of the reflective pixel electrodes, the light is reflected from the sides and allowed to penetrate the adjacent pixels. Thus, the contrast of displayed images is reduced. In addition, if light reflects diffusely at the sides, the amount of light penetrating the adjacent pixels is further increased, and thus the contrast is further reduced.

### BRIEF SUMMARY OF THE INVENTION

An advantage of some aspects of the invention is that it provides a liquid crystal device exhibiting a high contrast increased by a novel approach, that is, by preventing reflection from the side ends of the reflective pixel electrodes, and also provides an electronic apparatus including the liquid crystal device.

A first aspect of the invention is a liquid crystal device which includes a first substrate, an optically transparent second substrate, and a liquid crystal layer between the first and the second substrate. The first substrate includes a plurality of reflective pixel electrodes formed on a surface thereof and antireflection films on the sides of the reflective pixel electrodes. The second substrate opposes the surface having the pixel electrodes of the first substrate.

The liquid crystal device is of reflective type, and light entering through the second substrate is modulated in the liquid crystal layer, reflected from the reflective pixel electrodes, and emitted through the second substrate. In general, if light coming through the second substrate and passing through the spaces between the reflective pixel electrodes reflects from a layer below the pixel electrodes and enters on the side ends of the reflective pixel electrodes, causing the light to diverge into the adjacent pixels. In embodiments of the invention, however, the antireflection films are provided on the side ends of the reflective pixel electrodes so as to prevent reflection. Thus, even if light reaches the side ends, the light is not likely to reflect at the side ends. Since light is not easily reflected from the sides of the reflective pixel electrodes, the contrast of displayed images can be enhanced.

Another aspect of the invention is an electronic apparatus including the liquid crystal device described above. Such an electronic apparatus may be a cellular phone or a mobile computer.

Another aspect of the invention is an electronic apparatus, such, a projection display apparatus, which includes the liquid crystal device, a light source section supplying light to the liquid crystal device, and a projection optical system projecting light modulated by the liquid crystal device.

### BRIEF DESCRIPTION OF THE DRAWINGS

The invention will be described with reference to the accompanying drawings, wherein like numbers reference like elements.

FIG. 1 is a schematic diagram of an optical system of a projection display apparatus comprising an electronic apparatus according to an embodiment of the invention;

FIG. 2 is a block diagram of the electrical configuration of a liquid crystal device according to an embodiment of the invention;

FIG. 3A is a plan view of a liquid crystal panel of a liquid crystal device according to an embodiment of the invention, as viewed from the second substrate side;

FIG. 3B is a sectional view taken along line IIIB-IIIB in FIG. 3A;

FIG. 4A is a plan view of the arrangement of pixels of the first substrate used in a liquid crystal device according to an embodiment of the invention\;

FIG. 4B is a sectional view taken along line IVB-IVB in FIG. 4A;

FIGS. 5A to 5D are sectional views of process steps of a method for manufacturing a liquid crystal device according to an embodiment of the invention;

FIGS. 6A to 6C are sectional views of process steps of the method for manufacturing a liquid crystal device;

FIGS. 7A and 7B are sectional views of process steps of another method for manufacturing a liquid crystal device according to another embodiment of the invention;

FIG. 8 is a sectional view of a reflective liquid crystal device according to an embodiment of the invention; and

FIGS. 9A and 9B are representations of electronic apparatuses, each including a liquid crystal device according to an embodiment of the invention as a direct-view-type display unit.

### DESCRIPTION OF EXEMPLARY EMBODIMENTS

Embodiments of the invention will now be described with reference to the drawings. For the sake of visibility, the dimensional proportions of the layers and other members in the drawings may differ as needed.

### Projection Display Apparatus

### General Structure

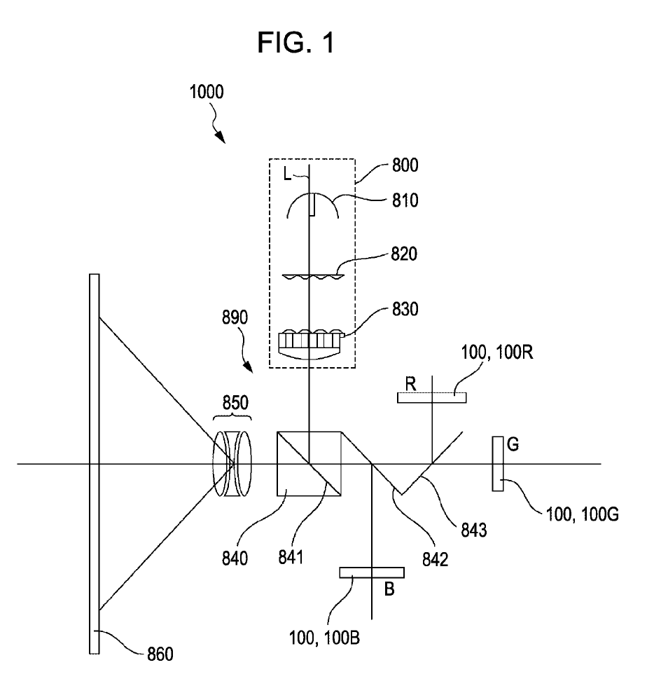

FIG. 1 is a schematic diagram of an optical system of a projection display apparatus which forms an electronic apparatus according to an embodiment of the invention. The projection display apparatus 1000 shown in FIG. 1 includes a light source section 890. The light source section 890 includes a polarization illuminating device 800 in which a light source 810, an integrator lens 820 and a polarization converter 830 are aligned along the optical axis L of the system. The light source section 890 also includes a polarized beam splitter 840 having an S polarized beam-reflecting surface 841 reflecting an S polarized beam emitted from the polarization illuminating device 800 along the optical axis L, a dichroic mirror 842 separating the blue light (B) component from the light reflected from the S polarized beam-reflecting surface 841, and a dichroic mirror 843 reflecting the red light (R) component to separate from the light from which the blue light component has been separated.

The projection display apparatus 1000 also includes three liquid crystal devices 100, referred to individually as 100R, 100G and 100B, into which respective color lights enter. The light source section 890 supplies respective color lights to the three liquid crystal devices 100R, 100G and 100B.

In the projection display apparatus 1000, lights modulated by the liquid crystal devices 100R, 100G and 100B are synthesized by a synthesizing section including the dichroic mirrors 842 and 843 and the polarized beam splitter 840, and then the synthesized light is projected onto a projection member, such as a screen 860, by a projection optical system 850.

The light source section of the projection display apparatus may have a structure which uses LED light sources emitting different color lights, where the lights emitted from the different LED light sources are supplied to their respective liquid crystal devices.

### Structure of Liquid Crystal Device

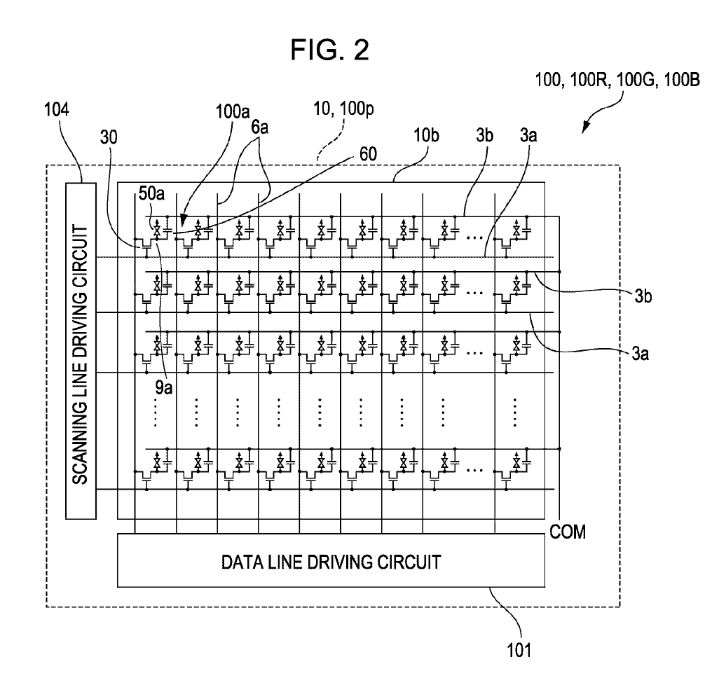

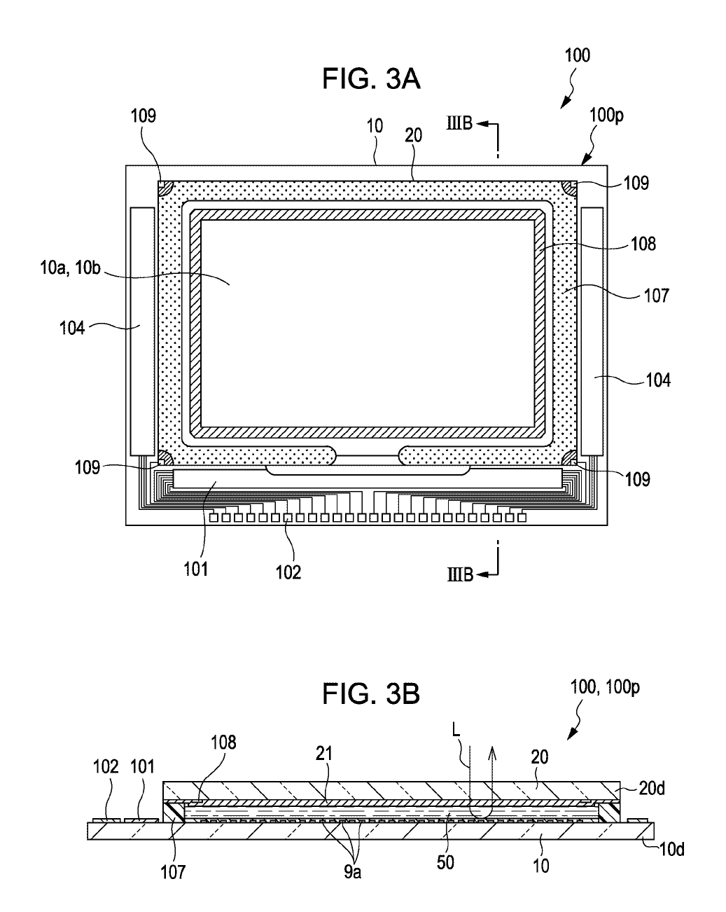

FIG. 2 is a block diagram of the electrical configuration of the liquid crystal device 100 used in the projection display apparatus shown in FIG. 1. FIG. 3A is a plan view of the liquid crystal panel 100p of the liquid crystal device 100 used in the projection display apparatus shown in FIG. 1, viewed from the second substrate side, and FIG. 3B is a sectional view taken along line IIIB-IIIB in FIG. 3A.

As shown in FIG. 2, the liquid crystal device 100 includes a twisted nematic (TN) or vertical alignment (VA) liquid crystal panel 100p. The liquid crystal panel 100p has a pixel region 10b in the middle portion in which a plurality of pixels 100a are arranged in a matrix configuration. The liquid crystal panel 100p includes a first substrate 10, which will be described in greater detail below. The first substrate has a plurality of data lines 6a and a plurality of scanning lines 3a within the pixel region 10b. The data lines 6a and the scanning lines 3a extend so as to intersect each other, and the pixels 100a are located corresponding to the intersections of the data lines 6a and the scanning lines 3a. Each pixel 100a includes a field-effect transistor acting as a pixel transistor 30, and a reflective pixel electrode 9a described more fully below. The source of the pixel transistor 30 is electrically connected with the data line 6a, and the gate of the pixel transistor 30 is electrically connected with the scanning line 3a. The drain of the pixel transistor 30 is electrically connected with the reflective pixel electrode 9a.

A scanning line driving circuit 104 and a data line driving circuit 101 are disposed in the outer region of the first substrate 10 outside the pixel region 10b. The data line driving circuit 101 is electrically connected to one end of each data line 6a, and transmits image signals supplied from an image processing circuit to the data lines 6a in a sequential manner. The scanning line driving circuit 104 is electrically connected to the scanning lines 3a, and transmits scanning signals to the scanning lines 3a in a sequential manner.

The reflective pixel electrodes 9a of the pixels 100a oppose a common electrode of a second substrate (described more fully below) with a liquid crystal layer therebetween, thus forming liquid crystal capacitors 50a. In each pixel 100a, a hold capacitor 60 is provided in parallel with the liquid crystal capacitor 50a so as to prevent the fluctuation of the image signal held in the liquid crystal capacitor 50a. In the present embodiment, capacitor lines 3b are disposed across the pixels 100a in parallel with the scanning lines 3a so as to define the hold capacitors 60.

In the liquid crystal panel 100p of the liquid crystal device 100, as shown in FIGS. 3A and 3B, the first substrate 10, also referred to herein as the element substrate, and the second substrate 20, also referred to herein as the opposing substrate, are bonded together with a sealant 107, so that a predetermined distance is formed therebetween. The sealant 107 is applied along the edge of the second substrate 20. The sealant 107 is an adhesive made of a photo-curable resin, a thermosetting resin or the like, and contains a gap material such as glass fiber or glass beads to maintain the predetermined distance between the substrates. In the present embodiment, the first substrate 10 includes an optically transparent body 10d, and the second substrate 20 includes an optically transparent body 20d as well. The body 10d of the first substrate 10 may be made of single crystal silicon.

The data line driving circuit 101 and a plurality of terminals 102 are disposed at the outer edge of the sealant 107, along one side of the first substrate 10, and the scanning line driving circuit 104 is disposed along another edge adjacent to that side of the first substrate 10. In addition, a vertical conductor 109 is provided in at least one corner of the second substrate 20 to establish an electrical continuity between the first substrate 10 and the second substrate.

The first substrate 10 has reflective pixel electrodes 9a that are formed of an aluminum material, such as aluminum or aluminum alloy, or a silver material, such as silver or silver alloy, which are formed in a matrix configuration. The pixel electrodes 9a will be described in greater detail below. In the present embodiment, the reflective pixel electrodes 9a are made of an aluminum material, such as aluminum or an aluminum alloy.

The second substrate 20 has a frame 108 made of a light-shielding material at the inner side of the sealant 107, and an image display region 10a is formed within the frame 108. The second substrate 20 has an indium tin oxide (ITO) common electrode 21, also referred to herein as an optically transparent electrode. The second substrate 20 may also have a light-shielding member (not shown) called black matrix or black stripe, opposing the regions between the reflective pixel electrodes 9a.

Dummy pixels may be provided in the region corresponding to the frame 108 in the pixel region 10b. In this instance, the pixel region 10b acts as the image display region 10a, except where the dummy pixel region is formed.

In the reflective liquid crystal device 100 having such a structure, light coming through the second substrate 20 is modulated in the liquid crystal layer 50, reflected from the reflective pixel electrodes 9a, and returned through the second substrate 20, as designated by the arrow L. Thus, an image is displayed. According to the type of the liquid crystal layer 50 and whether the normally white mode or the normally black mode, the second substrate 20 is provided with a retardation layer, a polarizer or the like in a predetermined orientation at the light incident side. Since the liquid crystal devices 100 of the projection display apparatus shown in FIG. 1 receive red, blue and green light respectively, color filters are not provided. If the liquid crystal device 100 is used as a color display unit of an electronic apparatus such as a mobile computer or a cellular phone, color filters and a protective film are provided to the second substrate 20.

### Structure of Pixels

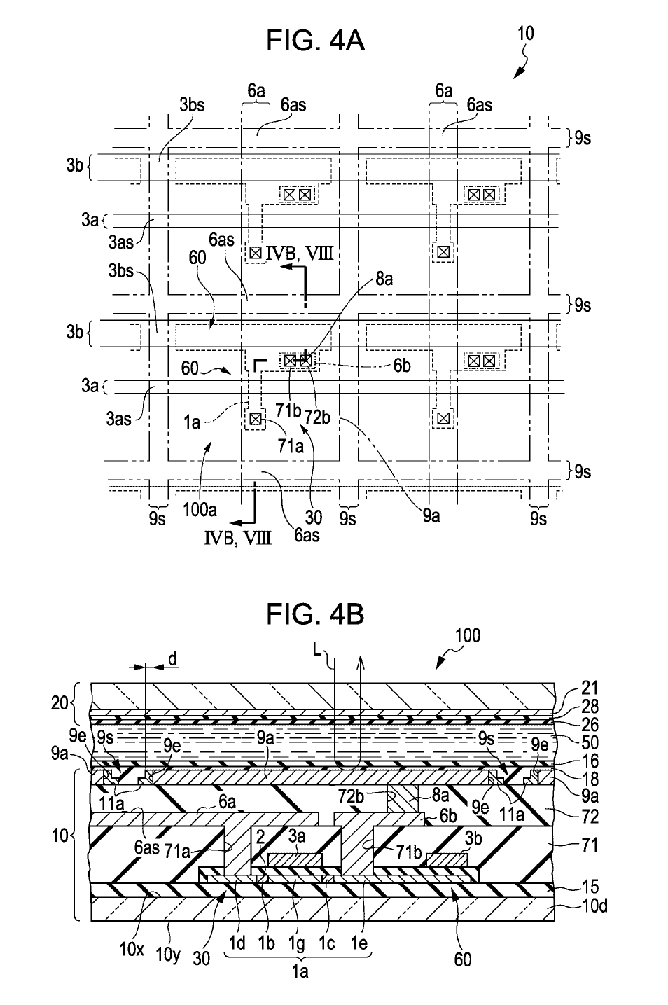

FIG. 4A is a plan view of the arrangement of pixels of the first substrate used in a reflective liquid crystal device according to an embodiment of the invention, and FIG. 4B is a sectional view taken along line IVB-IVB in FIG. 4A. In FIG. 4A, data lines 6a are indicated by dotted chain lines, scanning lines 3a and capacitor lines 3b are indicated by solid lines, semiconductor layers 1a are indicated by thin dotted lines, and reflective pixel electrodes 9a are indicated by chain double-dashed lines.

As shown in FIGS. 4A and 4B, the first substrate 10 includes a body 10d made of an optically transparent material, such as quartz or glass, or single crystal silicon. The substrate body 10d has a first surface 10x which is closer to the second substrate 20 and a second surface 10y opposite the first surface. The first surface 10x is coated with an optically transparent insulating underlayer 15 made of, for example, silicon oxide. The first substrate 10 has N-channel pixel transistors 30 over the insulating underlayer 15 in the regions corresponding to the reflective pixel electrodes 9a. The pixel transistors 30 are defined by semiconductor layers 1a formed of polysilicon or a single crystal semiconductor islands forming the transistors 30, each having an LDD (Lightly Doped Drain) structure including a channel region 1g, a lightly doped source region 1b, a heavily doped source region 1d, a lightly doped drain region 1c and a heavily doped drain region 1e. An optically transparent gate insulating layer 2 is formed of silicon oxide or silicon nitride on the surface of the semiconductor layer 1a. A gate electrode (scanning line 3a) is formed of a metal or doped silicon on the surface of the gate insulating layer 2. The capacitor line 3b is disposed opposing the extension of the heavily doped drain region 1e of the semiconductor layer 1a with the gate insulating layer 2 formed therebetween, thus defining the hold capacitor 60.

Although the pixel transistor 30 in the present embodiment has an LDD structure, the pixel transistor may have a structure in which the heavily doped source region and the heavily doped drain region are self-aligned with the scanning line 3a. The gate insulating layer 2 may be formed of silicon oxide by thermal oxidation, or may be formed of silicon oxide or silicon nitride by CVD. Alternatively, the gate insulating layer 2 may have a multilayer structure including a silicon oxide formed by thermal oxidation and a silicon oxide or silicon nitride film formed by CVD or the like. If a single crystal silicon substrate is used as the substrate body 10d, the pixel transistors 30 may be formed in the single crystal silicon substrate itself.

Insulating interlayers 71 and 72 are formed of an optically transparent material, such as silicon oxide or silicon nitride, over the pixel transistors 30. Data lines 6a and drain electrodes 6b are formed of a metal or doped silicon on the surface of the insulating interlayer 71. The data line 6a is electrically connected to the heavily doped source region 1d through a contact hole 71a formed in the insulating interlayer 71, and the drain electrode 6b is electrically connected to the heavily doped drain region 1e through another contact hole 71b formed in the insulating interlayer 71. On the surface of the insulating interlayer 72, individual reflective pixel electrodes 9a are formed. The reflective pixel electrodes 9a are arranged with spaces 9s formed therebetween at intervals of about 0.5 μm.

The reflective pixel electrode 9a is electrically connected to the drain electrode 6b through a contact hole 72b formed in the insulating interlayer 72. For this electrical connection, the contact hole 72b is filled with an electroconductive plug 8a, and the reflective pixel electrode 9a is electrically connected to the drain electrode 6b through the plug 8a. The surface of the insulating interlayer 72 and the surface of the plug 8a are flush with each other so as to form a continuous flat plane, and the reflective pixel electrode 9a is formed on the flat plane.

In the present embodiment, an alignment layer 16 is formed over the reflective pixel electrodes 9a. The alignment layer 16 may be a resin film of polyimide or the like, or an obliquely deposited film of, for example, silicon oxide. In the present embodiment, the alignment layer 16 is an obliquely deposited film of silicon oxide or the like. For such an inorganic alignment layer, in the present embodiment, an insulating protective layer 18 of, for example, silicon oxide or silicon nitride is provided between the alignment layer 16 and the reflective pixel electrodes 9a. In this instance, the insulating protective layer 18 fills the spaces 9s between the reflective pixel electrodes 9a. Thus, the insulating protective layer 18 forms a continuous flat surface, and the alignment layer 16 is formed on this flat surface.

The second substrate 20 includes an optically transparent body 20d. An ITO common electrode 21 is formed over the entire surface of the substrate body 20d opposing the first substrate 10. An alignment layer 26 is formed on the surface of the common electrode 21, as in the first substrate 10. As with the alignment layer 16, the alignment layer 26 of the second substrate 20 may be a resin film of polyimide or the like, or an obliquely deposited film of, for example, silicon oxide. In the present embodiment, the alignment layer 26 is an obliquely deposited film of silicon oxide or the like. For the use of such an inorganic alignment layer, in the present embodiment, a protective layer 28 of, for example, silicon oxide or silicon nitride is provided between the alignment layer 26 and the common electrode 21.

The first substrate 10 and the second substrate 20 having the above-described structures are opposed to each other in such a manner that the reflective pixel electrodes 9a and the common electrode 21 oppose each other. A liquid crystal layer 50 of an electrooptic material is enclosed in the space between these substrates and is sealed with a sealant 107. When an electric filed is not applied from the reflective pixel electrodes 9a, the liquid crystal layer 50 is brought into a predetermined alignment by the alignment layers 16 and 26 of the first substrate 10 and the second substrate 20. The liquid crystal layer 50 may be formed of, for example, a nematic liquid crystal or a mixture of nematic liquid crystals.

### Side End of Reflective Pixel Electrode 9a

In the liquid crystal device 100 of the present embodiment, the side ends 9e of the reflective pixel electrodes 9a are each provided with an antireflection film 11a. The antireflection films 11a are made of titanium nitride, and prevent reflection from the side ends 9e of the reflective pixel electrodes 9a.

Preferably, the titanium nitride antireflection film 11a has a thickness of 25 nm or more. This is because when the thickness is 25 nm, the reflectance for the i ray (365 nm) is minimum. In addition, since titanium nitride is electroconductive, the antireflection films 11a provided on the side ends 9e of any one of the reflective pixel electrodes 9a must be separate from the antireflection films 11a provided on the side ends 9e of the other reflective pixel electrodes 9a. Otherwise, the adjacent reflective pixel electrodes may short-circuit. Accordingly, the upper limit of the thickness of the titanium nitride antireflection film 11a depends on the interval between the adjacent reflective pixel electrodes.

In this instance, the thickness of the antireflection film 11a refers to the dimension in the direction perpendicular to the surface of the side end 9e of the reflective pixel electrode 9a, as shown in FIG. 4B, but not in the thickness direction of the liquid crystal layer 50.

In the present embodiment, the reflective pixel electrodes 9a are disposed with spaces 9s at intervals of 0.5 μm, and the antireflection film 11a has a thickness of 25 nm or less. Hence, the antireflection films 11a are each separate from the antireflection film 11a of the adjacent reflective pixel electrode 9a. Thus, the adjacent reflective pixel electrodes 9a do not short-circuit.

In the present embodiment, the antireflection films 11a are formed by patterning using side walls formed at the side ends 9e of the reflective pixel electrodes 9a, as will be described below. Consequently, the antireflection film 11a has an L shape including a portion formed on the side end 9e of the reflective pixel electrode 9a, and a portion partially covering the surface of the insulating interlayer 72 in the space 9s.

The liquid crystal device 100 of the present embodiment is used as a light valve (including the red light-modulating liquid crystal device 100R, the green light-modulating liquid crystal device 100G or the blue light-modulating liquid crystal device 100B described with reference to FIG. 1), and the wavelength of incident light is therefore limited. Accordingly, the thickness of the antireflection film 11a may be varied according to the wavelength of light entering the liquid crystal device 100. Antireflection films 11a having the same structure may be formed in all the light valves (red, green and blue light-modulating liquid crystal devices 100R, 100G and 100B).

### Preparation of First Substrate 10 of Liquid Crystal Device 100

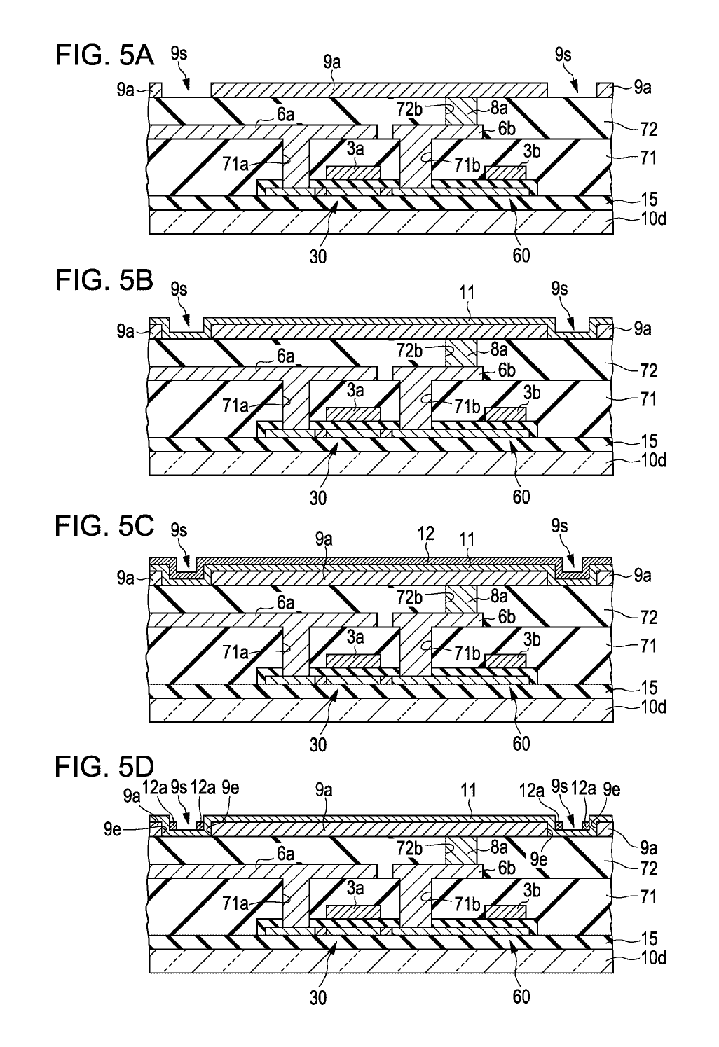

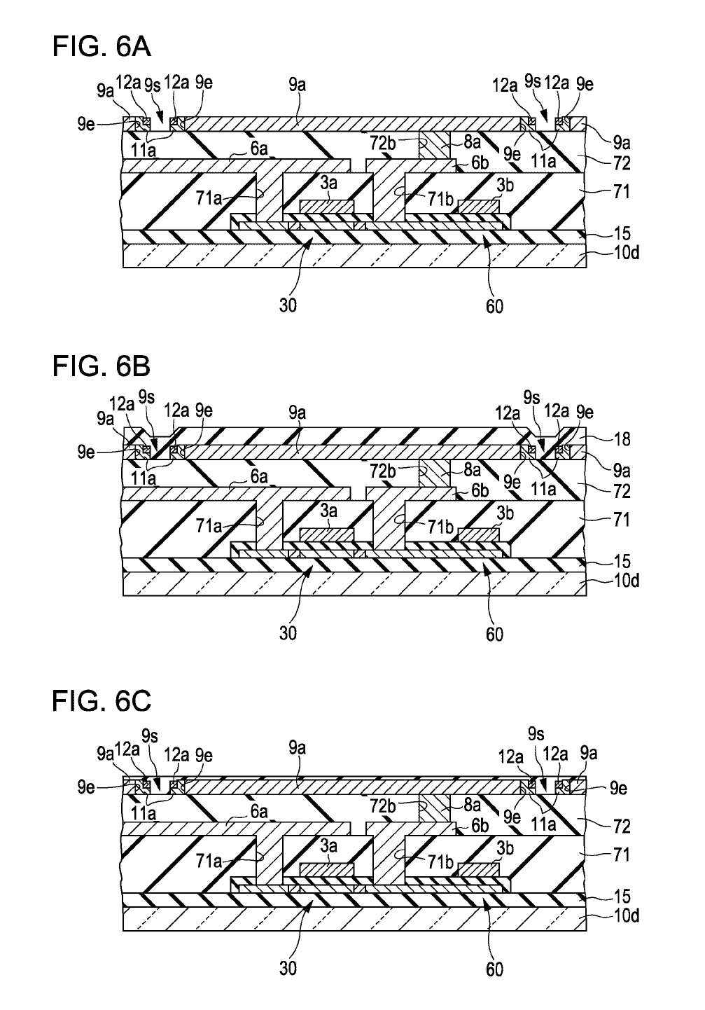

The structure of the liquid crystal device 100 will be further described through a method for manufacturing the liquid crystal device 100 with reference to FIGS. 5A to 5D and 6A to 6C. FIGS. 5A to 5D and 6A to 6C are sectional views showing a method for manufacturing the liquid crystal device 100, beginning with a step after the reflective pixel electrodes 9a are formed and concluding at the step for forming the insulating protective layer 18.

First, as shown in FIG. 5A, individual reflective pixel electrodes 9a are formed in an island manner. In the present embodiment, the surfaces of the reflective pixel electrodes 9a are polished to a mirror-smooth state. For polishing, chemical mechanical polishing process can be performed. The chemical mechanical polishing can produce a smooth surface at a high speed using the chemicals in the polishing liquid and the relative movement of the abrasives and the first substrate 10. More specifically, the surface is polished by relatively rotating a surface plate provided with abrasive cloth, such as nonwoven cloth, polyurethane foam, or porous fluorocarbon polymer cloth, relative to a holder holding the first substrate 10. For this polishing, an abrasive agent containing, for example, cerium oxide particles, a dispersant of an acrylic ester derivative and water is supplied between the abrasive cloth and the first substrate 10.

Turning now to FIG. 5B, a titanium nitride layer 11 is formed to cover the surfaces of the reflective pixel electrodes 9a and the insulating interlayer 72 exposed between the reflective pixel electrodes 9a at a thickness of about 25 nm, using a chemical vapor deposition (CVD) or sputtering method.

Then, as shown in FIG. 5C, a silicon oxide layer 12 is formed to cover the surface of the titanium nitride layer 11 by CVD or the like. The silicon oxide layer 12 is etched by reactive ion etching to leave side walls 12a at the side ends 9e of the reflective pixel electrodes 9a, as shown in FIG. 6D.

Turning now to FIG. 6A, the titanium nitride layer 11 is etched by a wet or dry process using the side walls 12a as etching masks. As a result, the titanium nitride layer 11 remains only on the side ends 9e of the reflective pixel electrodes 9a covered with the side walls 12a. The remainder of the titanium nitride layer 11 will act as the antireflection films 11a. The portions of the titanium nitride layer 11 exposed at the side walls 12a in the space 9s between the adjacent reflective pixel electrodes 9a are removed. Consequently, any two antireflection films 11a formed on the side ends 9e of the adjacent reflective pixel electrodes 9a are separated from each other.

Subsequently, as shown in FIG. 6B, the insulating protective layer 18 is formed of, for example, silicon oxide or silicon nitride by CVD or the like, so as to cover the reflective pixel electrodes 9a, the side walls 12a, and the antireflection films 11a. Thus, the spaces 9s (recesses) previously formed between the reflective pixel electrodes 9a are filled with the insulating protective layer 18.

The insulating protective layer 18 is then polished. As a result, the insulating protective layer 18 remains with a small thickness on the surfaces of the reflective pixel electrodes 9a to form a continuous flat surface, as shown in FIG. 6C. This polishing is performed by chemical mechanical polishing.

After the above process, the alignment layer 16 is formed by obliquely depositing silicon oxide or the like to cover the surface of the insulating protective layer 18, as shown in FIG. 4B.

### EFFECTS OF THE EMBODIMENT

As described above, the liquid crystal device 100 of the present embodiment is of a reflective type, and in which light entering through the second substrate 20 is modulated in the liquid crystal layer 50, reflected from the reflective pixel electrodes 9a, and then emitted through the second substrate 20. In the devices currently known in the art, light entering through the second substrate 20 and passing through the spaces 9s between the reflective pixel electrodes 9a reflects from the wiring or electric conductors in a layer below the pixel electrodes and reflects on the side ends 9e of the reflective pixel electrodes 9a and diverges into the adjacent pixels 100a. For example, in a liquid crystal device 100 as shown in FIG. 4A, the data lines 6a formed in a layer below the reflective pixel electrodes 9a extend in the regions under some of the spaces 9s between the reflective pixel electrodes 9a. Light entering through the second substrate 20 and passing through the spaces 9s reflects from the portions 6 as of the data line 6a toward the side ends 9e of the reflective pixel electrodes 9a. Also, the scanning lines 3a and the capacitor lines 3b formed in a layer below the reflective pixel electrodes 9a extend in the regions under other spaces 9s between the reflective pixel electrodes 9a. Light entering through the second substrate 20 and passing through the spaces 9s reflects from the portions 3as and 3bs of the scanning line 3a and capacitor line 3b toward the side ends 9e of the reflective pixel electrodes 9a.

In the present embodiment, however, the antireflection films 11a are provided on the side ends 9e of the reflective pixel electrodes 9a, so that the light reflected from the data line 6a, the scanning line 3a and the capacitor line 3b is not reflected at the side ends 9e of the reflective pixel electrodes 9a even if the light reaches the side ends 9e of the reflective pixel electrodes 9a. The antireflection films 11a can prevent light from being reflected at the side ends 9e of the reflective pixel electrodes 9a and into the adjacent pixels 100a, thus enhancing the contrast of displayed images.

In addition, by forming the antireflection film 11a so as to cover the entire side end of the reflective pixel electrode 9a, the reflection from the side end 9e of the reflective pixel electrode 9a can be more reliably prevented, and the contrast of displayed images can further be enhanced.

Unlike light-absorbing antireflection films, the antireflection film 11a does not store heat even though they receive light, because the antireflection film 11a is made of titanium nitride. Since heat generation in the antireflection films 11a can be prevented, the temperature of the liquid crystal device 100 does not increase in spite of the presence of the antireflection films 11a. Thus, high reliability can be maintained.

Further, any adjacent antireflection films 11a are separate from each other. Accordingly, even though the antireflection film 11a is made of electroconductive titanium nitride, the reflective pixel electrode 9a is not short-circuited due to the adjacent pixel electrodes 9a.

The spaces 9s between the reflective pixel electrodes 9a are filled with the insulating protective layer 18, and the surface of the insulating protective layer 18 is polished to be planarized. Since the alignment layer 16 can therefore be formed on the flat surface, the alignment layer 16 can function to uniformly align the molecules of the liquid crystal layer 50.

### Other Preparation of First Substrate

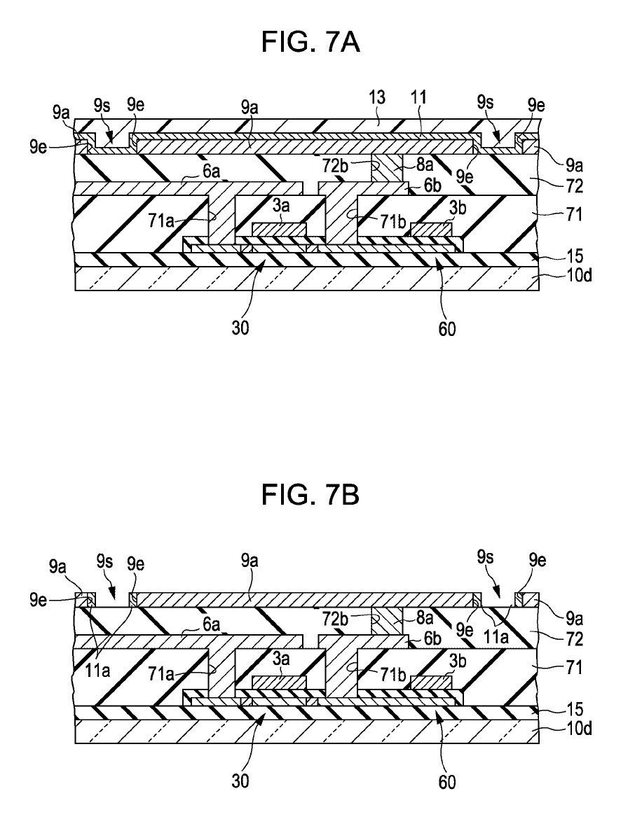

Although the side walls 12a are used as etching masks to leave the antireflection films 11a on the side ends 9e of the reflective pixel electrodes 9a in the above embodiment, the antireflection films 11a may be left on the side ends 9e of the pixel electrodes 9a by etch-back in an alternative embodiment, as will be described with reference to FIGS. 7A and 7B.

FIGS. 7A and 7B are sectional views of process steps of another method for manufacturing the liquid crystal device 100. In this method, as described above, a titanium nitride layer 11 is formed to cover the surfaces of the reflective pixel electrodes 9a and the insulating interlayer 72 exposed between the reflective pixel electrodes 9a, as shown in FIG. 7A.

Subsequently, a planarizing layer 13 is formed to cover the titanium nitride layer 11 using a spin-on-glass (SOG) material or a resist. The entire surface of the planarizing layer 13 is etched by anisotropic dry etching. In this instance, the etching speed of the planarizing layer 13 is set to be higher than the etching speeds of the titanium nitride layer 11 and the reflective pixel electrodes 9a. The titanium nitride layer 11 has a larger thickness at the side ends 9e of the reflective pixel electrodes 9a. Accordingly, by continuing the etching until the titanium nitride layer 11 is removed from the surfaces of the reflective pixel electrodes 9a and the bottoms of the spaces 9s (recesses), after removing the planarizing layer 13 by etching, the titanium nitride layer 11 remains as the antireflection films 11 on the side ends 9e of the reflective pixel electrodes 9a, as shown in FIG. 7B.

### Antireflection Structure of Conductor Lines

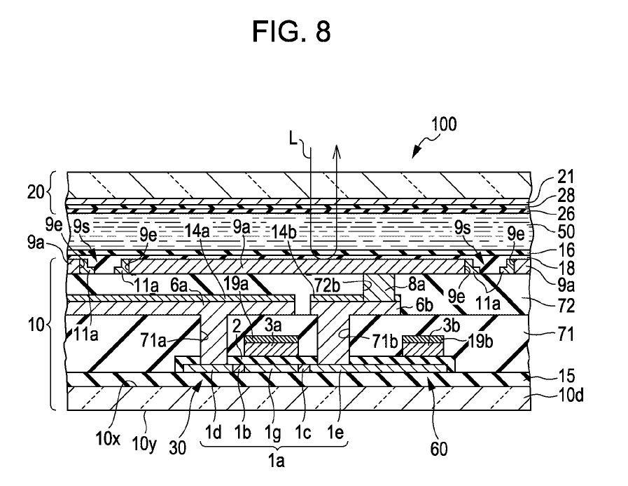

FIG. 8 is a sectional view of a reflective liquid crystal device 100 according to another embodiment of the invention, taken along a line corresponding to line IVB-IVB in FIG. 4A.

In the liquid crystal device 100 shown in FIG. 8, an antireflection layer 14a is formed of titanium nitride or the like on the upper surface of the data line 6a. Consequently, light passing through the spaces 9s between the reflective pixel electrodes 9a is not likely to reflect from the surface of the data line 6a. The data line 6a prevents light from reflecting to the side ends 9e of the reflective pixel electrodes 9a and, hence, from reflecting from the side ends 9e, thus enhancing the contrast. If the light passing through the spaces 9s reflects from the data line 6a and then further reflects from, for example, the lower surface of the reflective pixel electrode 9a to enter the pixel transistor 30, a photo-leakage current occurs. However, since the data line 6a of the present embodiment does not reflect light, photo-leakage current does not occur. In the present embodiment, the antireflection layers 14a are formed together with the data lines 6a using a patterning process, and thus the antireflection layers 14a have the same shape as the data lines 6a. In addition, another antireflection layer 14b similar to the antireflection layer 14a is formed on the surface of the drain electrode 6b.

Furthermore, antireflection layers 19a and 19b are formed of titanium nitride or the like on the surfaces of the scanning line 3a and the capacitor line 3b. Consequently, light passing through the spaces 9s is not reflected from the surfaces of the scanning line 3a and the capacitor line 3b. Thus, the scanning line 3a and the capacitor line 3b prevent light from reflecting to the side ends 9e of the reflective pixel electrodes 9a and from reflecting from the side ends 9e, thus enhancing the contrast. If the light passing through the spaces 9s reflects from the scanning line 3a and the capacitor line 3b then further reflects from, for example, the lower surface of the reflective pixel electrode 9a to enter the pixel transistor 30, a photo-leakage current occurs. However, since the scanning line 3a and the capacitor line of the present embodiment do does not reflect light, photo-leakage current does not occur in the pixel transistor. In the present embodiment, the antireflection layers 19a and 19b are formed together with the scanning lines 3a and the capacitor lines 3b by patterning, and thus the antireflection layers 19a and 19b have the same shape as the scanning line 3a and the capacitor line 3b.

Although the antireflection layer 14a and the antireflection layers 19a and 19b are formed on the surfaces of the data line 6a, the scanning line 3a and the capacitor line 3b, respectively, either the antireflection layer 14a or the antireflection films 19a and 19b may be formed.

### Other Embodiments

Although the antireflection film 11a comprises a titanium nitride single layer in the above embodiments, the antireflection film may be made of a metal oxide, nitride or silicide, such as of indium, zirconium, tantalum or tungsten, or silicon carbide, or may have a multilayer structure including such a layer.

The antireflection film 11a may be made of a dielectric material. The thickness of the dielectric antireflection film 11a can be determined as below. Since the antireflection film 11a generally receives visible light having wavelengths of 430 to 750, the thickness d (nm) of the antireflection film 11a can be set so that the refractive index n of the antireflection film 11a for light having a reference wavelength λ in the range of 430 to 750 nm and the thickness d (nm) of the antireflection film 11a satisfy the following relationship:

(λ/4)×k≈nd

where k represents a positive odd number.

The antireflection films of the red, green and blue light-modulating liquid crystal devices 100R 100G and 100B may have their respective optimal structures. For example, the red light-modulating liquid crystal device 100R may have an antireflection film 11a suitable for light having a reference wavelength λ in the region of red light (about 650 to 750 nm), the green light-modulating liquid crystal device 100G may have an antireflection film 11a suitable for light having a reference wavelength λ in the region of green light (about 530 to 550 nm), and the blue light-modulating liquid crystal device 100B may have an antireflection film 11a suitable for light having a reference wavelength λ in the region of blue light (about 430 to 480 nm). Alternatively, antireflection films 11a having the same structure may be formed in any of the light valves (red, green and blue light-modulating liquid crystal devices 100R, 100G and 100B).

### Installation to Other Electronic Apparatus

Although the above embodiments describe the liquid crystal device 100 used as a light valve in the projection display apparatus 1000, the liquid crystal device 100 may be used as a direct-view type display unit of an electronic apparatus described below.

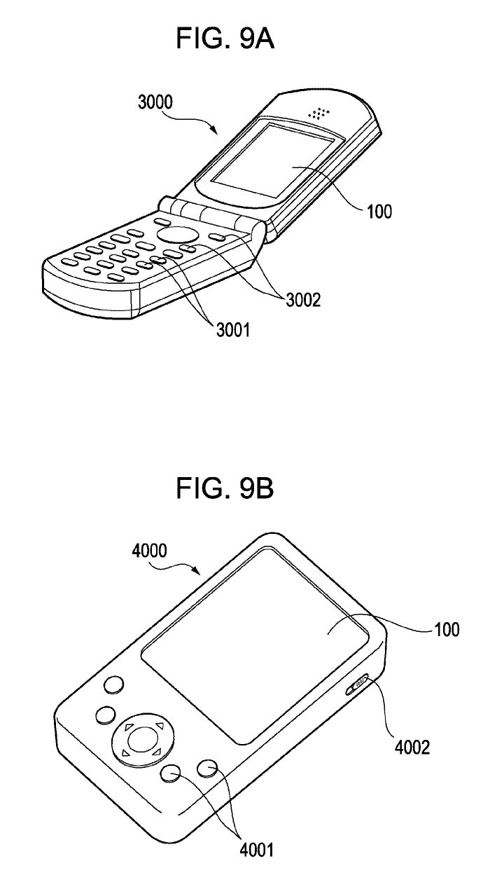

FIGS. 9A and 9B are representations of electronic apparatuses, each including a reflective liquid crystal device 100 according to an embodiment of the invention as a direct-view-type display unit. FIG. 9A shows a cellular phone 3000 including a plurality of control buttons 3001, scroll buttons 3002, and a liquid crystal device 100 as a display unit. By operating the scroll buttons 3002, images displayed on the liquid crystal device 100 are scrolled. FIG. 9B shows a personal digital assistant (PDA) 4000 including a plurality of control buttons 4001, a power switch 4002, and the liquid crystal device 100 as a display unit. By operating the power switch 4002, information, such as addresses and schedules, is displayed on the liquid crystal device 100. In addition to the electronic apparatuses shown in FIGS. 9A and 9B, the liquid crystal device 100 according to an embodiment of the invention can also be used in other electronic apparatuses, such as head-mount displays, digital still cameras, liquid crystal TV sets, viewfinder-type or monitor-direct-view-type video tape recorders, car navigation systems, pagers, electronic notebooks, electronic calculators, word processors, work stations, videophones, POS terminals, and bank terminals.

What is claimed is:

1. A liquid crystal device comprising:
a first substrate including a plurality of reflective pixel electrodes formed on a surface thereof and first antireflection films formed on either side the reflective pixel electrodes;
an optically transparent second substrate opposing the surface of the first substrate; and
a liquid crystal layer formed between the first substrate and the optically transparent second substrate.

2. The liquid crystal device according to claim 1, wherein the first antireflection films are electrically conductive, and wherein the first antireflection films formed on either side of the reflective pixel electrodes are separated from each other.

3. The liquid crystal device according to claim 2, wherein the first antireflection films are made of titanium nitride.

4. The liquid crystal device according to claim 3, wherein the first antireflection films have a thickness of 25 nm or more.

5. The liquid crystal device according to claim 1, wherein the first antireflection films are made of a dielectric material.

6. The liquid crystal device according to claim 5, wherein the first antireflection films have a thickness d and a refractive index n for light having a reference wavelength λ in the range of 430 to 750 nm, the thickness d and the refractive index satisfying the relationship:
(λ/4)×k≈nd,
wherein k represents a positive odd number.

7. The liquid crystal device according to claim 1, wherein the first substrate further includes electric conductors formed at a layer in the first substrate, wherein the reflective pixel electrodes are formed between the liquid crystal layer and the layer at which the electric conductors formed, and wherein an second antireflection film is formed on the surfaces of the electric conductors on a side closer which is to the reflective pixel electrodes in regions corresponding to the regions between the reflective pixel electrodes.

8. An electronic apparatus comprising the liquid crystal device according to claim 1.

9. An electronic apparatus comprising:
the liquid crystal device according to claim 1, the liquid crystal device modulating light;
a light source section supplying light to the liquid crystal device; and
a projection optical system projecting light modulated by the liquid crystal device.

10. An electronic apparatus comprising:
a liquid crystal device capable of modulating light including:
a first substrate including a plurality of reflective pixel electrodes formed on a surface thereof and antireflection films formed on either side the reflective pixel electrodes;
an optically transparent second substrate opposing the surface of the first substrate; and
a liquid crystal layer formed between the first substrate and the optically transparent second substrate;
a light source section supplying light to the liquid crystal device; and
a projection optical system projecting light modulated by the liquid crystal device,
wherein the antireflection films are formed of a dielectric material so as to be electrically conductive, and wherein the antireflection films formed on either side of the reflective pixel electrodes are separated from each other.
